(19) United States
(12) Patent Application Publication
(10) Pub. No.: US 2026/0058398 A1
(43) Pub. Date: Feb. 26, 2026

(54) BUS BAR MODULE CASE AND BUS BAR MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Seigo Mochizuki, Fujieda-shi (JP)

(21) Appl. No.: 19/304,609

(22) Filed: Aug. 20, 2025

(30) Foreign Application Priority Data
Aug. 22, 2024 (JP) 2024-140722

(51) Int. Cl. H01R 13/50; H01M 50/298; H01M 50/507

(52) U.S. Cl. CPC H01R 13/501; H01M 50/507; H01M 50/298

(57) ABSTRACT

A bus bar module case includes: a case body having a plurality of bus bar cavities for accommodating bus bars connected to a plurality of electrodes of battery cells placed side by side, and a wiring path provided with a wiring member including a trunk and a plurality of branch portions and electrically connected to the bus bars; a cover including a trunk protection portion protecting the trunk and a plurality of branch protection portions protecting the branch portions; a hinge unit connecting the cover to the case body via the branch protection portions; and a lock unit locking the cover to the case body.

### CROSS-REFERENCE TO RELATED APPLICATION(S)

The present application claims priority to and incorporates by reference the entire contents of Japanese Patent Application No. 2024-140722 filed in Japan on Aug. 22, 2024.

### BACKGROUND OF THE INVENTION

### 1. Field of the Invention

The present invention relates to a bus bar module case and a bus bar module.

### 2. Description of the Related Art

As a technique related to a bus bar module case and a bus bar module of the related art, for example, JP 2014-093 218 A discloses a bus bar module attached to a side surface of a battery assembly to configure a power supply device. A bus bar module includes a case. The case includes a plurality of bus bar accommodation units, a voltage detection terminal that is provided adjacent to each bus bar accommodation unit, a wiring unit that wires a voltage detection line connected to the voltage detection terminal, a cover that covers a predetermined range of the wiring unit, a hinge unit that displaces the cover to a closing position at which an opening of the wiring unit is covered and an opening position at which the opening of the wiring unit is exposed, and a lock unit that locks the cover at the closing position.

In the bus bar module case and the bus bar module, for example, the cover is opened and closed by the hinge unit and locked by the lock unit, but there is room for further improvement in the configuration including the placement of the hinge unit and the lock unit.

### SUMMARY OF THE INVENTION

In view of the above circumstances, the present invention has been made, and an object of the present invention is to provide a bus bar module case and a bus bar module capable of appropriately implementing a configuration of a cover.

In order to achieve the above mentioned object, a bus bar module case according to one aspect of the present invention includes a case body including a plurality of bus bar cavities for accommodating bus bars connected to electrodes of a plurality of battery cells placed side by side, and a wiring path provided with a wiring member that includes a trunk and a plurality of branch portions and electrically connected to the bus bars; a cover including a trunk protection portion protecting the trunk and a plurality of branch protection portions protecting the branch portions; a hinge unit connecting the cover to the case body via the branch protection portion; and a lock unit locking the cover to the case body.

In order to achieve the above mentioned object, a bus bar module according to another aspect of the present invention includes a bus bar connected to an electrode of each of a plurality of battery cells placed side by side; a wiring member including a trunk and a plurality of branch portions and electrically connected to the bus bar; and a bus bar module case, wherein the bus bar module case includes a case body including a plurality of bus bar cavities for accommodating the bus bars and a wiring path in which the wiring member is provided, and a cover including a trunk protection portion protecting the trunk and a plurality of branch protection portions protecting the branch portions, a hinge unit connecting the cover to the case body via the branch protection portion, and a lock unit locking the cover to the case body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a state in which a cover of a bus bar module according to an embodiment is opened;

FIG. 2 is an enlarged front view illustrating a portion P1 in FIG. 1;

FIG. 3 is an enlarged perspective view when viewed in a P2 direction in FIG. 1;

FIG. 4 is a perspective view illustrating a state in which the cover of the bus bar module according to the embodiment is closed;

FIG. 5 is a cross-sectional view taken along line V-V of FIG. 4;

FIG. 6 is a perspective view illustrating a state in which a cover of a bus bar module according to a modified example of the embodiment is opened; and

FIG. 7 is a perspective view illustrating a state in which the cover of the bus bar module according to the modified example of the embodiment is closed.

### DETAILED DESCRIPTION OF THE PREFERRED EMBODIMENTS

Hereinafter, an embodiment according to the present invention will be described in detail with reference to the drawings. The present invention is not limited by the embodiment. Constituents in the following embodiments include those that can be easily replaced by those skilled in the art or those that are substantially the same.

### EMBODIMENT

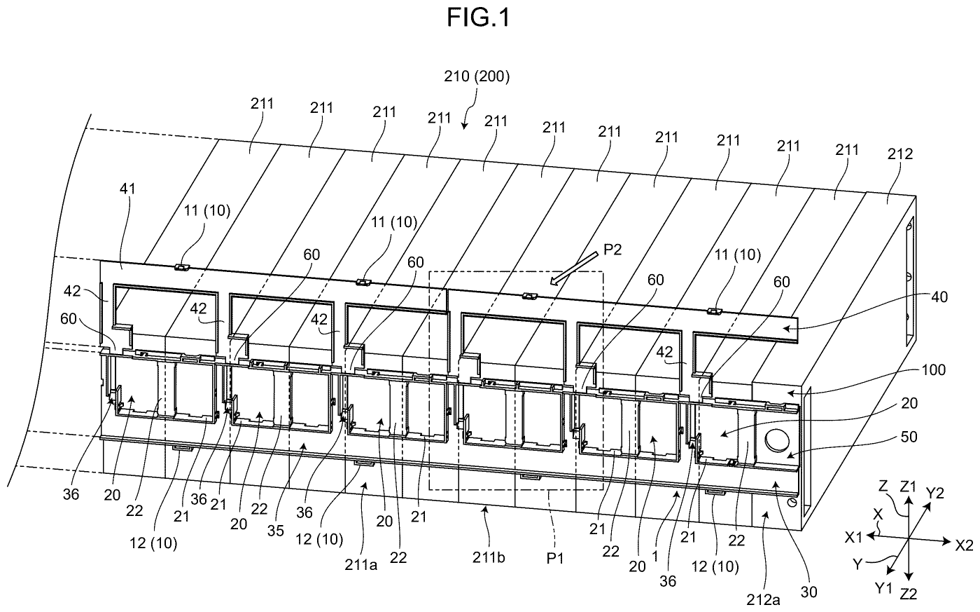

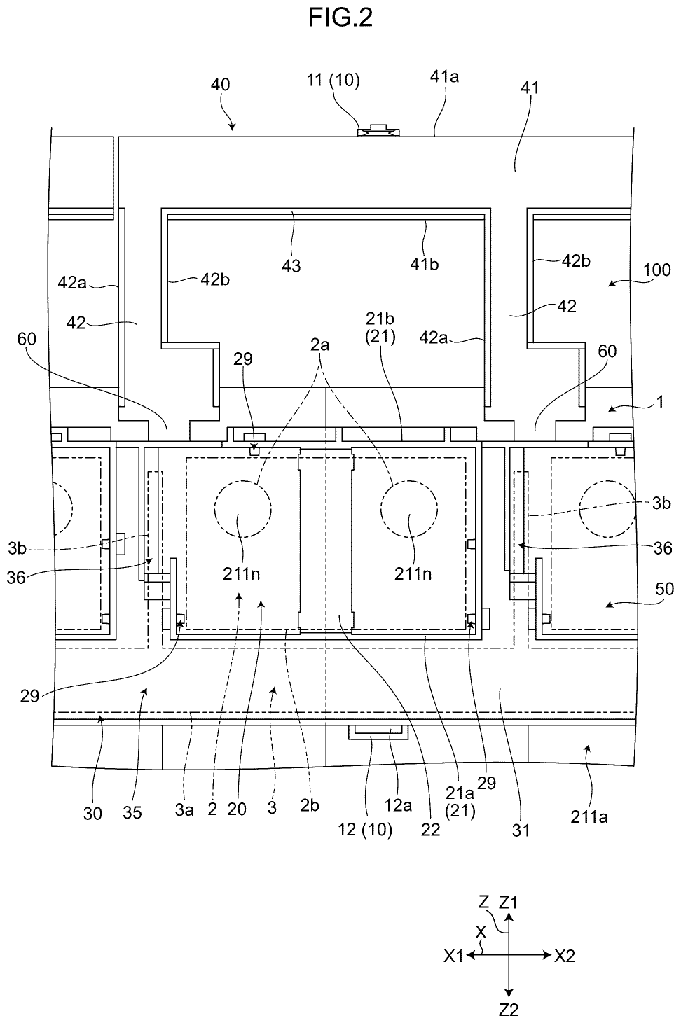

As illustrated in FIGS. 1 and 2, a battery module 210 according to the present embodiment includes a plurality of battery cells 211 and a bus bar module 1. The battery module 210 according to the present embodiment is a constituent element of the battery pack 200. The battery pack 200 may include a plurality of battery modules 210. The battery pack 200 is mounted as a power source on, for example, a vehicle such as an electric vehicle or a hybrid electric vehicle.

In the following description, a direction in which the plurality of battery cells 211 are placed side by side is referred to as a first direction X, and two directions orthogonal to the first direction X are referred to as a second direction Y and a third direction Z. The third direction Z is a direction perpendicular to an installation surfaces 211b of the plurality of battery cells 211. In the following description, one side in the first direction X is referred to as one side X1, and the other side is referred to as the other side X2. Similarly, the second direction Y is referred to as one side Y1 and the other side Y2, and the third direction Z is referred to as one side Z1 and the other side Z2. In the following description, the third direction Z may be referred to as a vertical direction, one side Z1 may be referred to as an upper side, and the other side Z2 may be referred to as a lower side.

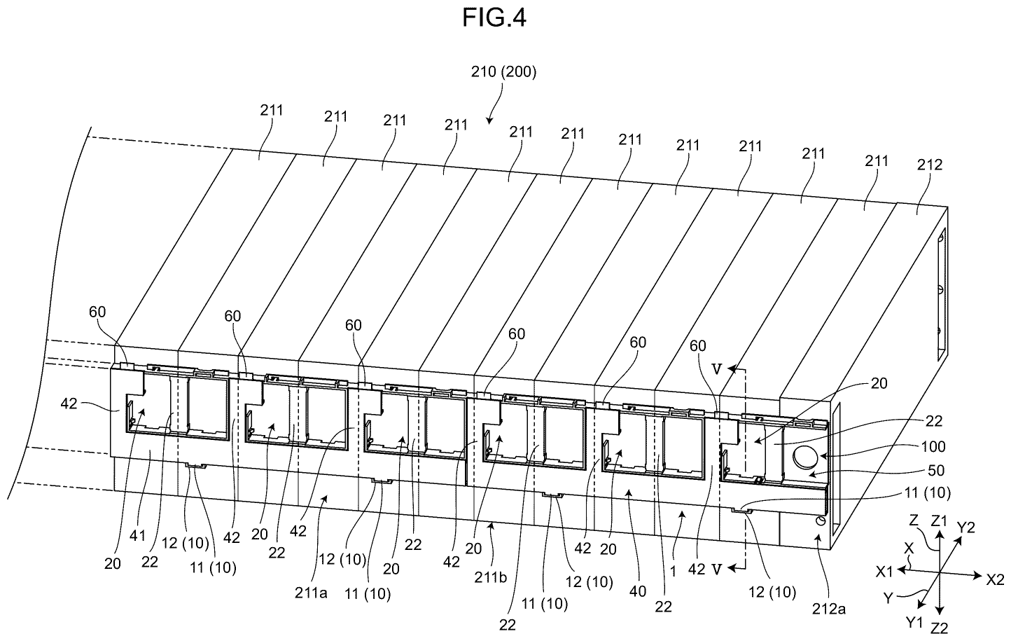

The battery cells 211 form a so-called unit battery, and constitute an assembled battery by arranging a plurality of the battery cells in the first direction X. Surfaces (not illustrated) on one side Y1 and the other side Y2 of the second direction Y of the plurality of battery cells 211 constituting the assembled battery are electrode placement surfaces 211a (the electrode placement surface 211a on the other side Y2 is not illustrated) on which an electrodes 211n of the respective battery cells 211 are placed. The electrode placement surface 211a is a surface parallel to a surface including the first direction X and the third direction Z. In each battery cell 211, a positive electrode is disposed on one electrode placement surface 211a of the two electrode placement surfaces 211a, and a negative electrode is disposed on the other electrode placement surface 211a. The bus bar module 1 is provided on each of the two electrode placement surfaces 211a. The bus bar module 1 is formed in an elongated shape in the first direction X, but only a part of the bus bar module 1 is illustrated in FIGS. 1 and 4.

A plate member 212 formed in a plate shape is provided at an end of the battery module 210 (the plurality of battery cells 211). The plate member 212 according to the present embodiment is a member called an end plate, and is formed of, for example, synthetic resin. The plate member 212 is placed at both ends of the plurality of battery cells 211 to sandwich and hold the plurality of battery cells 211 placed side by side. In FIG. 1, the plate member 212 placed at the end on the other side X2 of the first direction X is illustrated, and the plate member 212 disposed at the end on the one side X1 is not illustrated (the same applies to FIGS. 4, 6, and 7). The plate member 212 has a bus bar module placement surface 212a in the third direction Z on each of one side Y1 and the other side Y2 of the second direction Y. An end of the bus bar module 1 is placed on the bus bar module placement surface 212a. The bus bar module placement surface 212a is aligned with the electrode placement surface 211a of the battery cell 211 in the first direction X.

As illustrated in FIG. 2, the bus bar module 1 includes a bus bar module case 100, a bus bar 2, and a wiring member 3. The bus bar 2 and the wiring member 3 are illustrated only in FIG. 2. The bus bar module case 100 is integrally formed of an insulating resin material. The bus bar module case 100 includes a case body 50, a cover 40, a hinge unit 60, and a lock unit 10. The cover 40 is provided so that the cover 40 can be opened and closed with respect to the case body 50. The case body 50 includes a case body-side locking portion 12 of the lock unit 10, a bus bar cavity 20 accommodating the bus bar 2 therein, and a wiring path 30 in which the wiring member 3 is provided. The bus bar cavity 20 and the wiring path 30 are integrated to form the case body 50. The wiring path 30 includes a trunk wiring path 35 in which a trunk 3a of the wiring member 3 is provided and a branch wiring path 36 in which a branch portion 3b of the wiring member 3 is provided. The bus bar module case 100 will be described in detail later.

The bus bar 2 is connected to the electrodes 211n of the battery cells 211 in the plurality of battery cells 211 placed side by side in the first direction X. The bus bar 2 is a conductor formed of a conductive metal plate. The bus bar 2 is formed in a substantially long rectangular shape that has the first direction X as a longitudinal direction to be connected to each electrode 211n of the adjacent battery cells 211. In the present embodiment, at the end of the battery module 210, the bus bar 2 is connected to one electrode 211n of the battery cell 211 at the end. The bus bar 2 includes an electrode connection hole 2a which is a round hole penetrating therethrough. The bus bar 2 is fixed to the electrode 211n via the electrode connection hole 2a. The bus bar 2 connects, for example, two adjacent battery cells 211 in series. In this case, the bus bar 2 connects the positive electrode of one battery cell 211 and the negative electrode of the other battery cell 211. The bus bar 2 may be configured to connect two adjacent battery cells 211 in parallel. Although the bus bar 2 is illustrated in a substantially flat plate shape in the present embodiment, the bus bar 2 may have a convex portion following a beam portion 22 to be described below so that the bus bar 2 does not interfere with the beam portion 22.

The wiring member 3 is, for example, a flat wiring member such as a flexible printed circuit board. When the wiring member 3 is a flexible printed circuit board, the wiring member 3 has a base film, a coverlay, and a conductive layer. The base film and the coverlay are flexible insulating resin layers. The conductive layer is sandwiched between the base film and the coverlay for protection. The conductive layer is, for example, a conductive metal foil, and has a plurality of circuit patterns connected to the bus bar 2. The wiring member 3 is electrically connected to the bus bar 2 and includes the trunk 3a placed in the first direction X and a branch portion 3b extending from the trunk 3a to one side Z1 in the third direction Z.

The bus bar module 1 may be provided with a voltage detection terminal (not illustrated). The voltage detection terminal is electrically connected to the bus bar 2 and the branch portion 3b of the wiring member 3. The voltage detection terminal detects a voltage between the electrodes of the bus bar 2, and a voltage of the battery cell 211 is monitored by a monitoring device (not illustrated) connected to the wiring member 3.

The bus bar cavity 20 in the case body 50 of the bus bar module case 100 includes a side wall 21. The side wall 21 is formed in a substantially frame shape in which one side Y1 and the other side Y2 of the second direction Y are opened, and is erected around an end edge 2b serving as an outer circumference of the bus bar 2. The side wall 21 is formed in a substantially rectangular shape that has the first direction X as a longitudinal direction so that a substantially plate-like member is erected substantially perpendicular to the electrode placement surface 211a and surrounds the bus bar 2.

The side wall 21 on one side X1 of the first direction X is divided into one side Z1 and the other side Z2 of the third direction Z and separated in the first direction X. A portion where the side wall 21 on one side X1 of the first direction X is separated is a branch wiring path 36 of the wiring path 30 through which the branch portion 3b of the wiring member 3 is wired. In a substantially central portion in the first direction X inside the bus bar cavity 20, the beam portion 22 is provided from the side wall 21 on one side Z1 to the side wall 21 on the other side Z2 of the third direction Z. Although not illustrated, the beam portion 22 has a substantially U-shaped cross section parallel to a plane including the first direction X and the second direction Y. The beam portion 22 is provided such that the substantially U-shaped opening side faces the other side Y2 of the second direction Y. The side wall 21 is provided with a plurality of bus bar locking portions 29. Each of the bus bar locking portions 29 is formed in a leaf spring shape to which an elastic force is applied by forming slits on both sides. The bus bar 2 accommodated in the bus bar cavity 20 can be fixed by the bus bar locking portion 29.

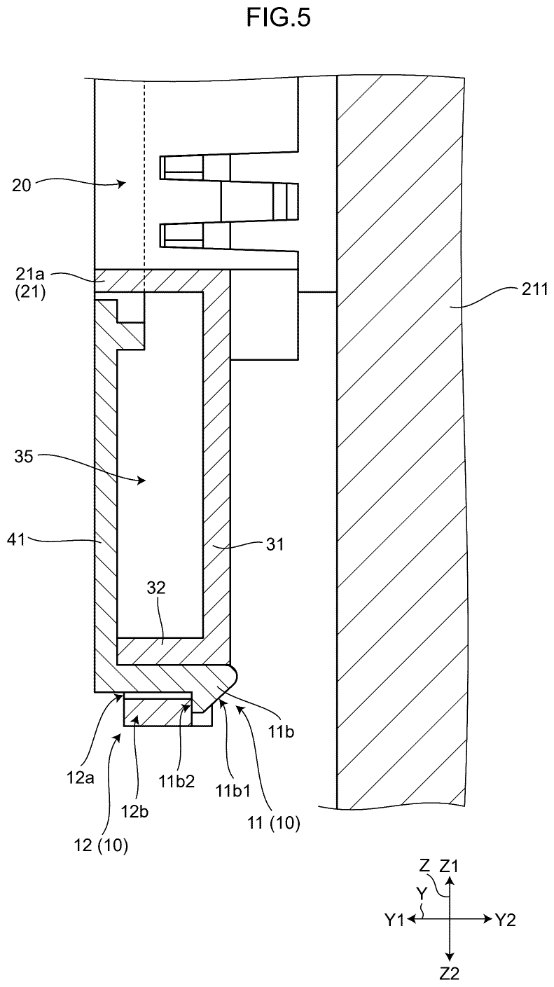

As illustrated in FIGS. 2 and 5, the trunk wiring path 35 of the wiring path 30 in the bus bar module case 100 is provided on the other side Z2 of the bus bar cavity 20 in the third direction Z. In a state where the bus bar module 1 is placed in the plurality of battery cells 211 (hereinafter simply referred to as a “placement state”), the other side Z2 of the third direction Z is a lower side of the bus bar cavity 20 in the vertical direction. The wiring path 30 includes a main plate 31 and a bottom plate 32. The main plate 31 and the bottom plate 32 extend in the first direction X. The main plate 31 is connected to a lower wall 21a that is the side wall 21 on the other side Z2 of the third direction Z in the bus bar cavity 20, and is provided with a plate surface facing the second direction Y. The bottom plate 32 is connected to an end of the main plate 31 on the other side Z2 of the third direction Z, is formed to protrude toward one side Y1 of the second direction Y, and is provided with a plate surface facing the third direction Z. The trunk wiring path 35 is formed by the surface of the lower wall 21a on the other side Z2 of the third direction Z, the surface of the main plate 31 on the one side Y1 of the second direction Y, and the surface of the bottom plate 32 on the one side Z1 of the third direction Z. In the trunk wiring path 35, the trunk 3a of the wiring member 3 is wired. The trunk wiring path 35 is formed long in the first direction X.

On the surface of the bottom plate 32 of the wiring path 30 on the other side Z2 of the third direction Z, the case body-side locking portion 12 to which a cover-side locking portion 11 to be described below is locked is provided. The plurality of case body-side locking portions 12 are provided at predetermined intervals in the first direction X. The case body-side locking portion 12 is formed in a substantially rectangular cylindrical shape.

The cover 40 is formed in a substantially plate shape and is provided on one side Z1 (that is, the upper side of the case body 50) of the case body 50 in the third direction Z with the cover 40 being opened. The cover 40 includes a trunk protection portion 41 and a plurality of branch protection portions 42. In the present embodiment, in the cover 40, one trunk protection portion 41 and three branch protection portions 42 are integrated. In FIG. 1, two sets of covers 40 are illustrated. That is, the cover 40 can be divided and provided for every predetermined number of branch protection portions 42, and the plurality of covers 40 can be provided for one case body 50.

The trunk protection portion 41 of the cover 40 is formed in the first direction X. Each of the three branch protection portions 42 is formed in the third direction Z from the trunk protection portion 41. The branch protection portion 42 is formed toward the other side Z2 in the third direction Z with the cover 40 in FIG. 1 being opened. The distal end of the branch protection portion 42 is widely formed to protrude toward the other side X2 in the first direction X. Of two end edges 41a and 41b of the trunk protection portion 41, at the end edge 41b where the branch protection portion 42 is provided and at the end edges 42a and 42b of the branch protection portion 42, ribs 43 are provided along the end edges 41b, 42a, and 42b.

The hinge unit 60 connects the cover 40 to the case body 50 via the branch protection portion 42. Specifically, the hinge unit 60 is provided at a distal end of the branch protection portion 42 of the cover 40 and is connected to an upper side wall 21b (see FIG. 2) which is an upper side wall 21 of the bus bar cavity 20 of the case body 50. In other words, the hinge unit 60 is located on the upper side in the vertical direction in the placement state of the bus bar module 1 (bus bar module case 100). The hinge unit 60 is formed in a thin plate shape and is flexible.

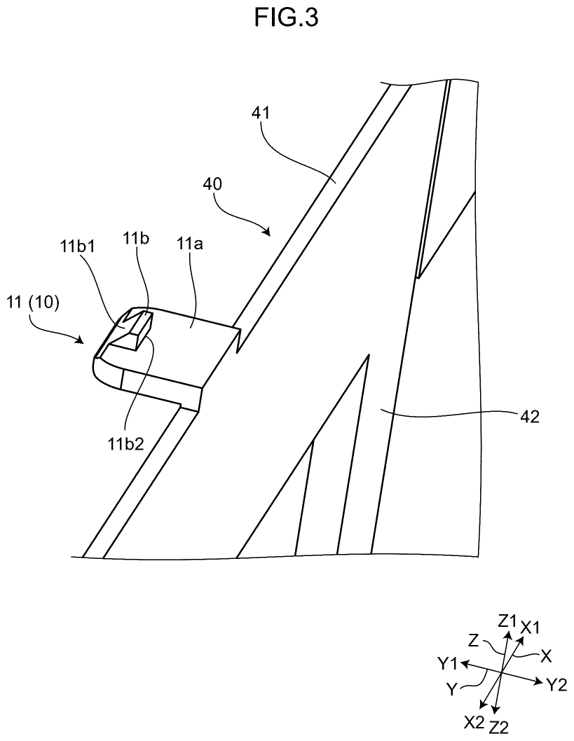

The cover-side locking portions 11 are provided at the end edge 41a of the trunk protection portion 41. The cover-side locking portions 11 are provided at predetermined intervals along the trunk protection portion 41 (the first direction X). In one set of covers 40 including three branch protection portions 42, two cover-side locking portions 11 are provided. The cover-side locking portion 11 is locked to the case body-side locking portion 12 provided in the wiring path 30 of the case body 50. The cover-side locking portion 11 and the case body-side locking portion 12 form the lock unit 10. As illustrated in FIG. 3, the cover-side locking portion 11 is provided with a base plate 11a protruding toward the one side Y1 of the second direction Y and a protrusion portion 11b protruding from a plate surface of the base plate 11a on the one side Z1 of the third direction Z with the cover 40 being opened. The protrusion portion 11b is formed in a substantially chevron shape in which an inclined surface 11b1 is inclined. In the protrusion portion 11b, a jaw 11b2 is formed on the opposite side of the inclined surface 11b1 in the second direction Y. The jaw 11b2 is formed perpendicular to the plate surface of the base plate 11a.

In the bus bar module 1 (the bus bar module case 100), when the cover 40 is closed, the wiring path 30 is covered with the cover 40 as illustrated in FIG. 4. The trunk protection portion 41 of the cover 40 covers the trunk wiring path 35 to protect the trunk 3a of the wiring member 3, and the branch protection portion 42 covers the branch wiring path 36 to protect the branch portion 3b. As illustrated in FIG. 5, when the cover 40 is in a closed state, the cover-side locking portion 11 of the lock unit 10 is inserted into and locked to the case body-side locking portion 12 of the lock unit 10. Specifically, the cover-side locking portion 11 is inserted into a through hole 12a of the case body-side locking portion 12 from the distal end side which is the inclined surface 11b1 side of the protrusion portion 11b of the cover-side locking portion 11, the through hole 12a (in particular, a lower plate portion 12b of the case body-side locking portion 12 on the other side Z2 of the third direction Z) is expanded by the inclined surface 11bl, and the jaw 11b2 of the protrusion portion 11b is locked to the end on the other side Y2 of the second direction Y of the case body-side locking portion 12. In other words, since the protrusion portion 11b of the cover-side locking portion 11 faces the lower side when the lock unit 10 is locked, the lower plate portion 12b of the case body-side locking portion 12 that has lower rigidity than the bottom plate 32 is expanded to be locked to the case body-side locking portion 12. That is, the protrusion portion 11b of the cover-side locking portion 11 protrudes toward the outside of the bus bar cavity 20, and a hole-shaped portion of the case body-side locking portion 12 that is deformable to correspond to the protrusion direction of the protrusion portion 11b is formed, so that the lock unit 10 can be formed with a simple configuration.

### Modified Examples

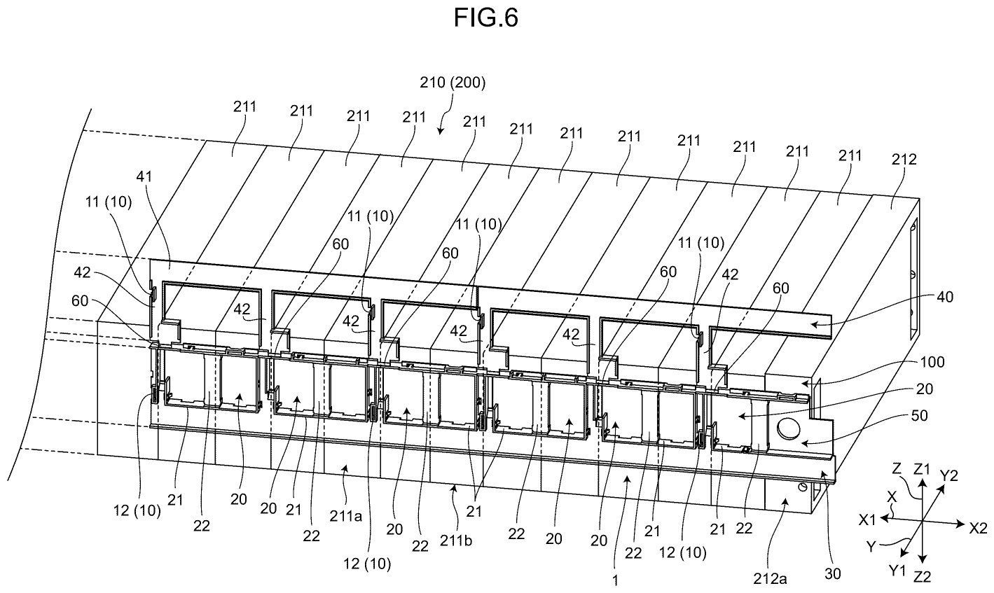

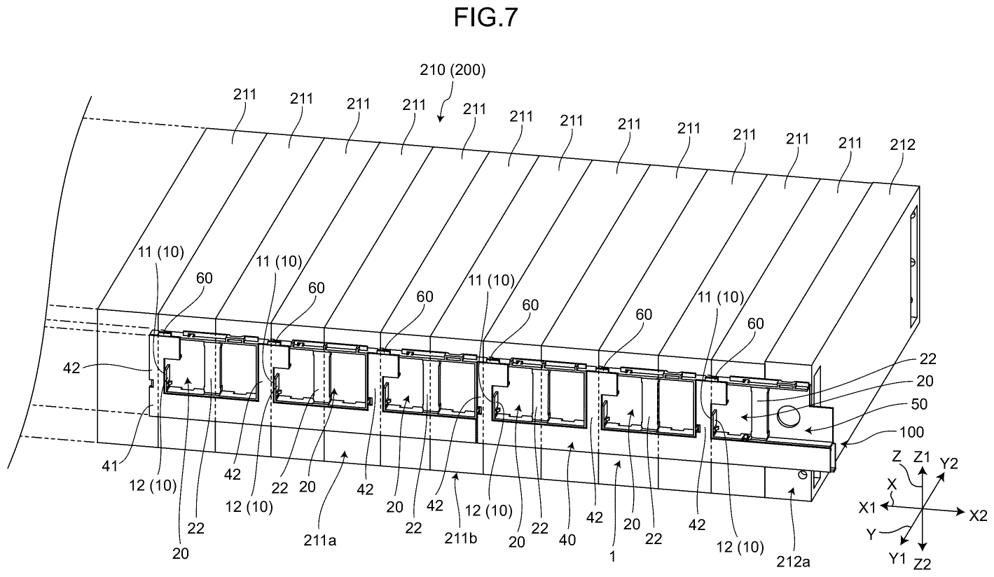

Modified examples of the present embodiment are illustrated in FIGS. 6 and 7. In the present modified example, the position of the lock unit 10 according to the present embodiment is changed, the cover-side locking portion 11 is provided in the branch protection portion 42, and the case body-side locking portion 12 is provided on the side of the branch wiring path 36. More specifically, the cover-side locking portion 11 is provided on the proximal end side of the branch protection portion 42 (the side of a portion where the branch protection portion 42 and the trunk protection portion 41 are connected), and the case body-side locking portion 12 is placed on the side of the branch wiring path 36 on the trunk wiring path 35 side (one side X1 in the first direction X) corresponding to the position of the cover-side locking portion 11. In this way, any position at which the lock unit 10 is placed can be set.

The above-described bus bar module case 100 includes the case body 50 that includes a plurality of bus bar cavities 20 for accommodating the bus bars 2 connected to the electrodes 211n of the battery cells 211 in the plurality of battery cells 211 placed side by side, and the wiring path 30 provided with the wiring member 3 that includes the trunk 3a and the plurality of branch portions 3b and electrically connected to the bus bars 2; the cover 40 that includes the trunk protection portion 41 protecting the trunk 3a and the plurality of branch protection portions 42 protecting the branch portions 3b; the hinge unit 60 that connects the cover 40 to the case body 50 via the branch protection portion 42; and the lock unit 10 that locks the cover 40 to the case body 50. The bus bar module 1 includes the bus bar 2, the wiring member 3, and the bus bar module case 100.

Accordingly, it is possible to provide the bus bar module case and the bus bar module capable of appropriately realizing the configuration of the cover. For example, in a case where the cover 40 is provided on the lower side of the case body 50, and the hinge unit 60 is provided between the trunk protection portion 41 and the bottom plate 32 of the wiring path 30 to connect the cover 40 and the case body 50 via the trunk protection portion 41 of the cover 40, the distal end of the branch protection portion 42 is in a free end state. Therefore, when the cover 40 is closed, rattling may occur particularly at the distal end of the thin branch protection portion 42. Therefore, in order to suppress this rattling, the lock unit 10 may be provided to be locked at the distal end of the branch protection portion 42. In particular, in the bus bar module 1 installed in an assembled battery used as a power source of a vehicle or the like, in order to suppress rattling due to vibration, the lock unit 10 may be provided and fixed to all the distal end portions of the branch protection portion 42. When the lock units 10 (the cover-side locking portions 11) are provided in all the branch protection portions 42, the number of the lock units 10 increases, the work of inserting and locking the cover-side locking portions 11 into the case body-side locking portions 12 increases, and the number of processes of assembling the bus bar module 1 may increase.

Therefore, according to the present embodiment, since the hinge unit 60 is provided to connect the cover 40 and the case body 50 via the branch protection portion 42 of the cover 40, the branch protection portion 42 does not become a free end, and thus it is not necessary to provide the lock unit 10 in each branch protection portion 42. Therefore, the number of the lock units 10 can be set to such a number that the cover 40 does not generate rattling due to vibration or the like, and the configuration of the cover 40 can be appropriately realized. In the present embodiment, the cover 40 can be locked to the case body 50 by the two lock units 10 with respect to the three branch protection portions 42, and it is not necessary to provide the same number of lock units 10 as the branch protection portions 42. That is, the bus bar module case 100 is provided with a smaller number of lock units 10 than the number of hinge units 60.

In addition, the hinge unit 60 is provided in all the branch protection portions 42. As a result, it is possible to reduce the branch protection portion 42 that becomes a free end.

Further, the lock unit 10 includes a cover-side locking portion 11 provided on the cover 40 and a case body-side locking portion 12 provided on the case body 50 and locked to the cover-side locking portion 11, and the cover-side locking portion 11 is provided on the trunk protection portion 41. As a result, the trunk protection portion 41 of the cover 40, which is a free end, can be more reliably locked to the case body 50.

Further, the lock unit 10 includes a cover-side locking portion 11 provided on the cover 40 and a case body-side locking portion 12 provided on the case body 50 and locked to the cover-side locking portion 11, and the cover-side locking portion 11 may be provided on the branch protection portion 42. Accordingly, the cover 40 can be locked to the case body 50 while fixing the branch protection portion 42.

In addition, the hinge unit 60 is provided at the distal end of the branch protection portion 42, and is located on the vertically upper side of the bus bar module case 100 (case body 50) in a state of being installed in the plurality of battery cells 211. As a result, the cover 40 can be opened and closed in the form of being opened upward, that is, the cover 40 can be opened and closed such that the other side Z2 of the cover 40 in the third direction Z approaches or separates from the case body 50. Therefore, even when the locking of the lock unit 10 is released, the cover 40 can be closed by its own weight.

Note that the bus bar module case and the bus bar module according to the above-described embodiments of the present invention are not limited to the above-described embodiments, and various modified examples can be made within the scope described in the claims.

In the above description, the lock unit 10 is provided on the end edge 41a of the trunk protection portion 41 of the cover 40 or the base end side of the branch protection portion 42, but the placement of the lock unit 10 can be set such that the cover-side locking portion 11 is at an arbitrary position of the cover 40. The lock unit 10 includes the cover-side locking portion 11 and the case body-side locking portion 12 that are concavo-convex fitted, but other locking structures can also be adopted. In addition, the hinge unit 60 may not be provided in all the branch protection portions 42. In addition to the flexible printed circuit board, a flexible flat cable or an electric wire can be used as the wiring member 3.

The bus bar module case and the bus bar module according to the present embodiment may be configured by appropriately combining the components of the embodiment and the modified examples described above.

The bus bar module case and the bus bar module according to the present embodiment have the advantage of appropriately implementing a configuration of the cover.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar module case comprising:
a case body including a plurality of bus bar cavities for accommodating bus bars connected to electrodes of a plurality of battery cells placed side by side, and a wiring path provided with a wiring member that includes a trunk and a plurality of branch portions and electrically connected to the bus bars;
a cover including a trunk protection portion protecting the trunk and a plurality of branch protection portions protecting the branch portions;
a hinge unit connecting the cover to the case body via the branch protection portion; and
a lock unit locking the cover to the case body.

2. The bus bar module case according to claim 1, wherein
the hinge unit is provided in all the branch protection portions.

3. The bus bar module case according to claim 1, wherein
the lock unit includes a cover-side locking portion provided in the cover and a case body-side locking portion provided in the case body and locked to the cover-side locking portion, and
the cover-side locking portion is provided in the trunk protection portion.

4. The bus bar module case according to claim 2, wherein
the lock unit includes a cover-side locking portion provided in the cover and a case body-side locking portion provided in the case body and locked to the cover-side locking portion, and
the cover-side locking portion is provided in the trunk protection portion.

5. The bus bar module case according to claim 1, wherein
the lock unit includes a cover-side locking portion provided in the cover and a case body-side locking portion provided in the case body and locked to the cover-side locking portion, and
the cover-side locking portion is provided in the branch protection portion.

6. The bus bar module case according to claim 2, wherein
the lock unit includes a cover-side locking portion provided in the cover and a case body-side locking portion provided in the case body and locked to the cover-side locking portion, and
the cover-side locking portion is provided in the branch protection portion.

7. The bus bar module case according to claim 1, wherein
the hinge unit is provided at a distal end of the branch protection portion and is located on an upper side in a vertical direction in a state of being installed in the plurality of battery cells.

8. The bus bar module case according to claim 2, wherein
the hinge unit is provided at a distal end of the branch protection portion and is located on an upper side in a vertical direction in a state of being installed in the plurality of battery cells.

9. A bus bar module comprising:
a bus bar connected to an electrode of each of a plurality of battery cells placed side by side;
a wiring member including a trunk and a plurality of branch portions and electrically connected to the bus bar; and
a bus bar module case, wherein
the bus bar module case includes
a case body including a plurality of bus bar cavities for accommodating the bus bars and a wiring path in which the wiring member is provided, and
a cover including a trunk protection portion protecting the trunk and a plurality of branch protection portions protecting the branch portions,
a hinge unit connecting the cover to the case body via the branch protection portion, and
a lock unit locking the cover to the case body.
